(19) United States
(12) Patent Application Publication
(10) Pub. No.: US 2012/0014850 A1
(43) Pub. Date: Jan. 19, 2012

(54) COMBUSTOR FOR REFORMER

(76) Inventor: In-Hyuk Son, Yongin-si (KR)

(21) Appl. No.: 13/020,698

(22) Filed: Feb. 3, 2011

(30) Foreign Application Priority Data
Jul. 16, 2010 (KR) 10-2010-0069037

(51) Int. Cl. B01J 8/02

(52) U.S. Cl. 422/608; 422/211

(57) ABSTRACT

A combustor provides heat to a reformer. The combustor includes an inner wall, a thermocouple, a fuel supply tube, a fuel distribution portion and a first oxidation catalytic layer. The inner wall is formed in a shape of a hollow cylinder having a first oxidation portion in a space therein. The thermocouple extends to the first oxidation portion to measure the temperature of the first oxidation portion. The fuel supply tube has a shape of a hollow cylinder surrounding the thermocouple, and has fuel discharge holes formed at a lower portion thereof. The fuel distribution portion is located below the fuel supply tube, and has distribution nozzles through which fuel is distributed. The first oxidation catalytic layer is located beneath the fuel distribution portion.

### CROSS-REFERENCE TO RELATED APPLICATION

This application claims priority to and the benefit of Korean Patent Application No. 10-2010-0069037, filed on Jul. 16, 2010, in the Korean Intellectual Property Office, the entire content of which is incorporated herein by reference.

### BACKGROUND

1. Field

Aspects of embodiments according to the present invention relate to a combustor that provides heat to a reformer.

2. Description of the Related Art

The reforming reaction in a fuel cell is a reaction that produces hydrogen that is used as fuel in the fuel cell from hydrocarbon-based fossil fuel, and an apparatus that performs such a reaction is referred to as a fuel processor. In addition to a reformer that performs a reforming reaction, the fuel processor may further include a reactor for decreasing the concentration of carbon monoxide if necessary and a desulfurizer for removing sulfur contained in the fuel.

In the case of an external reforming method, a fuel reformer includes a heat source and a reforming reactor. The heat source supplies heat necessary for a reforming reaction in the reforming reactor, and the reforming reactor reforms fuel to generate gas containing abundant hydrogen. In this instance, the reforming reactor reforms the supplied fuel using a steam reforming (SR or STR) method, a partial oxidation (POX) method or an autothermal reforming (ATR) method obtained by combining the two methods. Among these methods, the SR method is a method of obtaining hydrogen through a reaction of hydrocarbon fuel and steam. Since high-concentration hydrogen is obtained using the SR method, the power of a fuel cell can be increased. However, since the SR method is an endothermic reaction, external heat is necessarily supplied from the reforming reactor.

A combustor is a device that generates heat and high-temperature gas by oxidizing fuel. The heat and high temperature gas generated from the combustor may be used as a heat source for preheating of fuel or water. The combustor may be implemented using a method of directly burning fuel injected into a combustion chamber through spark ignition, a method of burning fuel through an oxidation catalyst, or the like. The device that oxidizes fuel through an oxidation catalyst is referred to as a catalyst combustor.

Since such a combustor is operated under a high-temperature atmosphere, there have been proposed various methods for durability of providing various types of components in the interior of the combustor.

### SUMMARY

An aspect of one embodiment is directed toward a combustor for a reformer, which can increase the durability of a thermocouple for measuring the internal temperature of the combustor.

An aspect of one embodiment is directed toward a combustor for a reformer, which can perform separate fuel distribution and prevent flashback.

An aspect of one embodiment is directed toward a connection structure between a combustor and an evaporator, which can simplify the number of components and enhance the power of a reformer.

According to an embodiment of the present invention, there is provided a combustor for a reformer. The combustor includes an inner wall, a thermocouple, a fuel supply tube, a fuel distribution portion and a first oxidation catalytic layer.

The inner wall has a shape of a hollow cylinder with a first oxidation portion in a space therein. The thermocouple extends to the first oxidation portion by passing through a top portion of the first oxidation portion so as to measure a temperature of the first oxidation portion. The fuel supply tube has a shape of a hollow cylinder surrounding the thermocouple, and has fuel discharge holes formed at a lower portion thereof. The fuel distribution portion is located below the fuel supply tube, and has distribution nozzles through which fuel is distributed. The first oxidation catalytic layer is located beneath the fuel distribution portion. The inner wall may have a shape of a hollow circular or polygonal cylinder. The fuel supply tube may have a shape of a hollow circular or polygonal cylinder.

The combustor may further include an outer wall surrounding the inner wall with a second oxidation portion in a space therebetween, a lower portion of the second oxidation portion being in fluid communication with the first oxidation portion, and a second oxidation catalyst layer in the second oxidation portion. A second oxidation catalytic layer may be located in the second oxidation portion.

The fuel discharge holes may be formed in a horizontal direction on a lower outer circumferential surface of the fuel supply tube.

The fuel distribution portion may include a nozzle plate having distribution nozzles formed therein and a thermal capacity portion with a cylindrical shape extending downward from a periphery of the nozzle plate. The thermal capacity portion may be in a shape of a circular or polygonal cylinder.

An area of the distribution nozzles may increase in proportion to a distance from a center axis of the nozzle plate.

According to an embodiment of the present invention, there is provided a reformer. The reformer includes an inner wall, an outer wall, a first oxidation catalytic layer, a second oxidation catalytic layer, a thermocouple, a fuel supply tube, a fuel distribution portion, an evaporator and a reforming portion.

The inner wall has a shape of a hollow cylinder with a first oxidation portion in a space therein. The outer wall surrounds the inner wall with a second oxidation portion in a space therebetween, and a lower portion of the second oxidation portion is in fluid communication with the first oxidation portion. The fuel distribution portion is in the first oxidation portion. The first oxidation catalyst layer is located beneath the fuel distribution portion. The second oxidation catalyst layer is located in the second oxidation portion. The thermocouple extends to the first oxidation portion by passing through a top portion of the first oxidation portion so as to measure a temperature of the first oxidation portion. The fuel supply tube has a shape of a hollow cylinder surrounding the thermocouple, and has fuel discharge holes formed at a lower portion thereof. The fuel distribution portion is located below the fuel supply tube, and has distribution nozzles through which fuel is distributed. The evaporator receives reforming fuel and water supplied thereto and evaporates the supplied water using heat energy of exhaust gas exhausted from the second oxidation catalyst layer. The evaporator discharges the reforming fuel and the evaporated water. The reforming portion receives heat energy transferred from the first and second oxidation portions to reform the reforming fuel and the evaporated water from the evaporator. The inner wall may have a shape of a hollow circular or polygonal cylinder. The fuel supply tube may have a shape of a hollow circular or polygonal cylinder.

The evaporator may include a plurality of plates formed in a multi-layered structure with a plurality of layers and flow path tubes for passing the water and exhaust gas between the layers so that the layers corresponding to the water and exhaust gas are alternately arranged. The inner wall may be welded to a second bottom plate at a bottom of the evaporator, and the outer wall may be welded to a first bottom plate at the bottom of the evaporator.

The fuel discharge holes may be formed in a horizontal direction on a lower outer circumferential surface of the fuel supply tube.

The fuel distribution portion may include a nozzle plate having distribution nozzles formed therein and a thermal capacity portion with a cylindrical shape extending downward from a periphery of the nozzle plate.

An area of the distribution nozzles may increase in proportion to a distance from a center axis of the nozzle plate.

As described above, according to embodiments of the present invention, a fuel supply tube is formed to surround a thermocouple, so that the durability of the thermocouple can be enhanced.

Also, a fuel distribution portion has a cap shape, so that its thermal capacity is increased, thereby reducing flashback. Thus, in a case where a separate flashback reduction device is not employed, the durability of the fuel distribution portion and the thermocouple can be enhanced.

Also, welding points are minimized in the connection structure between a combustor and an evaporator, so that heat exchange efficiency can be increased, and manufacturing time and cost can be saved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram schematically showing the configuration of a fuel cell system.

FIG. 2 is a longitudinal sectional view schematically showing an exemplary combustor.

FIG. 3 is a longitudinal sectional view schematically showing a combustor according to an embodiment of the present invention.

FIG. 4 is a cut-away perspective view showing a fuel distribution portion according to an embodiment of the present invention.

FIG. 5 is a plan view showing the fuel distribution portion according to an embodiment of the present invention.

FIG. 6 is a longitudinal sectional view schematically showing a combustor according to another embodiment of the present invention.

FIG. 7 is a longitudinal sectional view showing a connection structure between a combustor and an evaporator according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. When terms that indicate directions, such as top, bottom, left and right, are used without special notation, the terms indicate directions represented in the drawings.

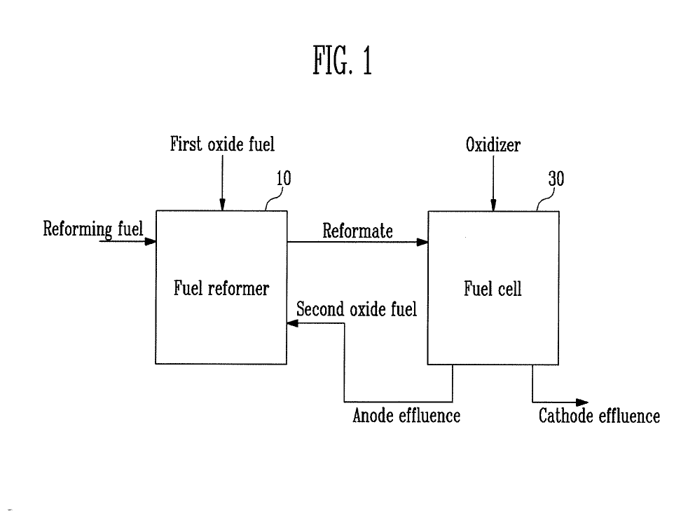

As shown in FIG. 1, a fuel reformer 10 receives reforming fuel supplied thereto and converts the supplied reforming fuel into a reformate for use in a fuel cell 30. Since a heat source is used in a case where the fuel reformer 10 converts the reforming fuel into the reformate using a steam reforming (SR) method, the fuel reformer 10 receives first oxide fuel supplied thereto for generating heat. In this case, anode-off gas (AOG) exhausted in a non-reaction state from an anode of the fuel cell 30 may be supplied as second oxide fuel to the fuel reformer 10 so as to enhance the efficiency of the entire fuel cell system. The fuel reformer 10 may include a reactor that reduces carbon monoxide using water-gas shift (WGS) and preferential oxidation (PROX) reactions.

An aspect of embodiments according to the present invention is directed toward a combustor that supplies heat to the fuel reformer 10 in the fuel cell system.

### First Embodiment

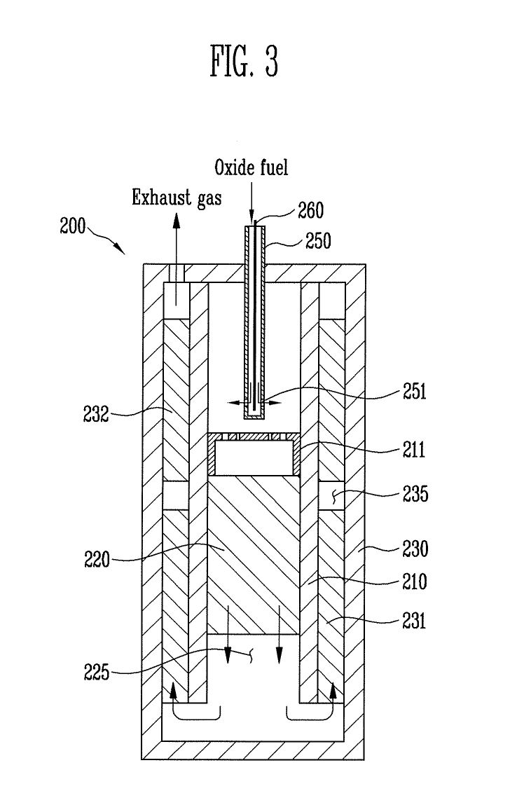

A combustor 200 will be described with reference to FIG. 3. The combustor 200 is generally divided into a first oxidation portion 225 and a second oxidation portion 235.

The first oxidation portion 225 is in the interior of a combustor inner wall 210 formed in the shape of a hollow cylinder (e.g., circular or polygonal cylinder). The second oxidation portion 235 is a space that surrounds an outside of the combustor inner wall 210. That is, a combustor outer wall 230 is formed in the shape of a hollow cylinder (e.g., circular or polygonal cylinder), and surrounds the combustor inner wall 210. That is, the second oxidation portion 235 is a space between the combustor inner and outer walls 210 and 230. The first and second oxidation portions 225 and 235 are connected so that fluid can flow therebetween at a lower portion of the combustor 200.

As shown in FIG. 3, a thermocouple 260 extends to the interior of the first oxidation portion 225 by passing through a top portion of the first oxidation portion 225. The thermocouple 260 is a device made of two kinds of metals to measure the temperature in a wide range using the Seeback effect. The thermocouple 260 measures the temperature of the interior of the first oxidation portion 225.

A fuel supply tube 250 is formed in the shape of a hollow circular or polygonal cylinder, and surrounds the exterior of the thermocouple 260. Fuel discharge holes 251 are formed at a lower portion of the fuel supply tube 250. Here, the fuel discharge holes 251 may be formed in a horizontal direction on a lower outer surface (e.g., a circumferential surface) of the fuel supply tube 250 so that fuel flowing in the fuel supply tube 250 is supplied to the first oxidation portion 225 in the horizontal direction. That is, the fuel supply tube 250 functions to supply oxide fuel supplied therethrough to the interior of the combustor 200 and to protect the thermocouple 260 in a high-temperature environment.

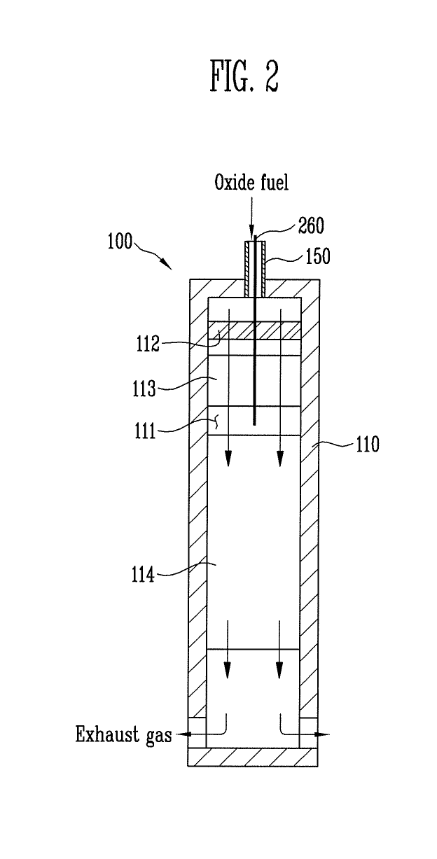

FIG. 2 shows an exemplary combustor. The combustor 100 of FIG. 2 has a configuration in which oxide fuel supplied through a fuel supply tube 150 is uniformly supplied through a fuel distributor 112 and oxidized by a first oxidation catalyst layer 114. In this case, a thermocouple 260 is exposed to the interior of a first oxidation portion 113, and hence, the thermocouple 260 may have serious deterioration under the high-temperature environment in a first combustion portion 111.

Here, the oxide fuel refers to a main fuel such as liquefied petroleum gas (LPG) for generating heat through an oxidation reaction. The oxide fuel may include alcohol series such as methanol, hydrocarbon series such as methane and butane, fossil fuel such as naphtha, liquefied natural gas (LNG), biomass, landfill gas (LFG), or a combination thereof. The AOG refers to non-combustible gas having hydrogen as a main component, exhausted from an anode of a fuel cell after electricity is produced in a fuel cell stack.

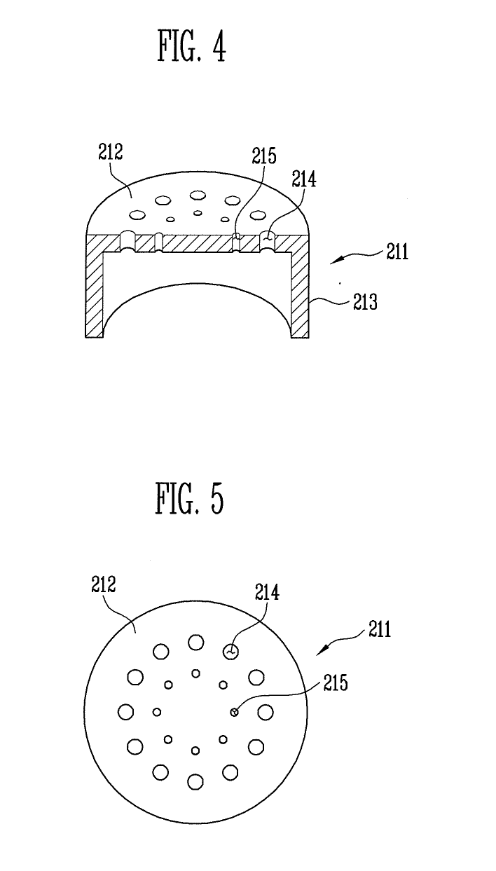

A fuel distribution portion 211 will be described with reference to FIGS. 3 to 5. The fuel distribution portion 211 is located below the fuel supply tube 251 described above to uniformly distribute the fuel. As shown in FIG. 4, the fuel distribution portion 211 is provided with a nozzle plate 212 formed in a shape corresponding to the sectional shape of the first oxidation portion 225 described above and a thermal capacity portion 213 formed to be extended downward from the periphery (e.g., circumference) of the nozzle plate 212. The fuel distribution portion 211 is formed in a cap shape, thereby increasing thermal capacity. Although flashback may occur due to such a cap shape, it is not transferred to the fuel discharge holes 251 formed at the fuel supply tube 250, so that stable operation is possible.

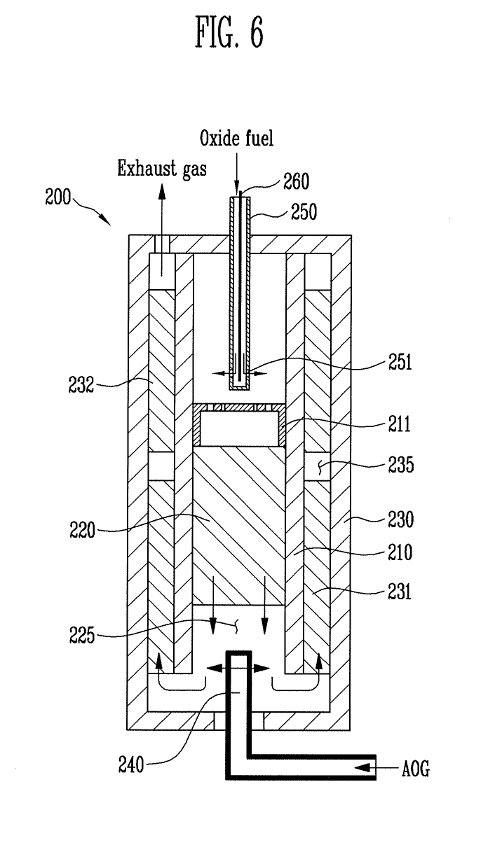

As shown in FIG. 5, a plurality of distribution nozzles 214 and 215 are formed in the nozzle plate 212. Here, the total area of the distribution nozzles 214 and 215 formed at certain distances from the center axis of the nozzle plate 212 may be in proportion to the corresponding distances. That is, the fuel distribution portion 211 induces the combustion of the oxide fuel to be performed at a periphery or circumference of the nozzle plate 212, having a relatively lower reaction temperature than a vicinity of the center axis of the nozzle plate 212, so that hot spots are uniformly distributed. The fuel distribution portion 211 may be made of metal, alloy, complex material or the like, which has suitable durability in a range of the temperature at which the first oxidation portion 225 is operated.

Here, since the fuel distribution portion 211 has a high thermal capacity, it serves as an anti-backfire portion. However, a separate anti-backfire portion may be provided to the fuel distribution portion 211. That is, an anti-backfire portion may be located between the fuel distribution portion 211 and the first oxidation catalyst layer 220. High-temperature hot spots are formed at an upper portion of the first oxidation catalyst layer 220, at which oxidation reaction is most actively performed. Here, the anti-backfire portion prevents the fuel from flowing backward in the direction of the fuel distribution portion 211. The anti-backfire portion may be made of a porous member or metal monolith having a cell density between about 400 and 600 cells per square inch (CPSI), which is similar to a support body of the first oxidation catalyst layer 220.

The first oxidation catalyst layer 220 is located in the interior of the first oxidation portion 225. The first oxidation catalyst layer 220 is provided with a mesh- or monolith-shaped support body having a space through which a fluid passes, and an active material is coated on the surface of the support body. The first oxidation catalyst layer 220 functions to increase a combustion rate by inducing stable combustion without flashback of the oxide fuel or AOG, and to control positions at which hot spots are formed. The active material may include Pd, Pt, Co₃O₄, PdO, Cr₂O₃, Mn₂O₃, CuO, Fe₂O₃, V₂O₃, NiO, MoO₃, TiO₂ or a mixture thereof. The support body of the first oxidation catalyst layer 220 may have a cell density between about 400 and 600 CPSI for the purpose of proper fluid pressure and effective oxidation reaction of the fuel.

A second oxidation catalyst layer 231 is located in the interior of the second oxidation portion 235. The second oxidation catalyst layer 231 may be formed by forming a mesh- or monolith-shaped support body having a cell density between about 100 and 200 CPSI, and an oxidation catalyst is coated on the surface of the support body. The support body may be made of metal such as chrome-based stainless steel (Fe—Cr) having a high melting point, alloy, complex material or the like, so as to have suitable durability at a high temperature. Like the active material in the first oxidation catalyst layer 220, the oxidation catalyst may include Pd, Pt, Co₃O₄, PdO, Cr₂O₃, Mn₂O₃, CuO, Fe₂O₃, V₂O₃, NiO, MoO₃, TiO₂ or a mixture thereof. Here, the second oxidation catalyst layer 231 may be divided into two portions spaced apart from each other at a suitable interval in the interior of the second oxidation portion 235.

Portions such as a reforming portion, an igniter and a preheater, which are not directly related to the present invention, will be omitted.

### Second Embodiment

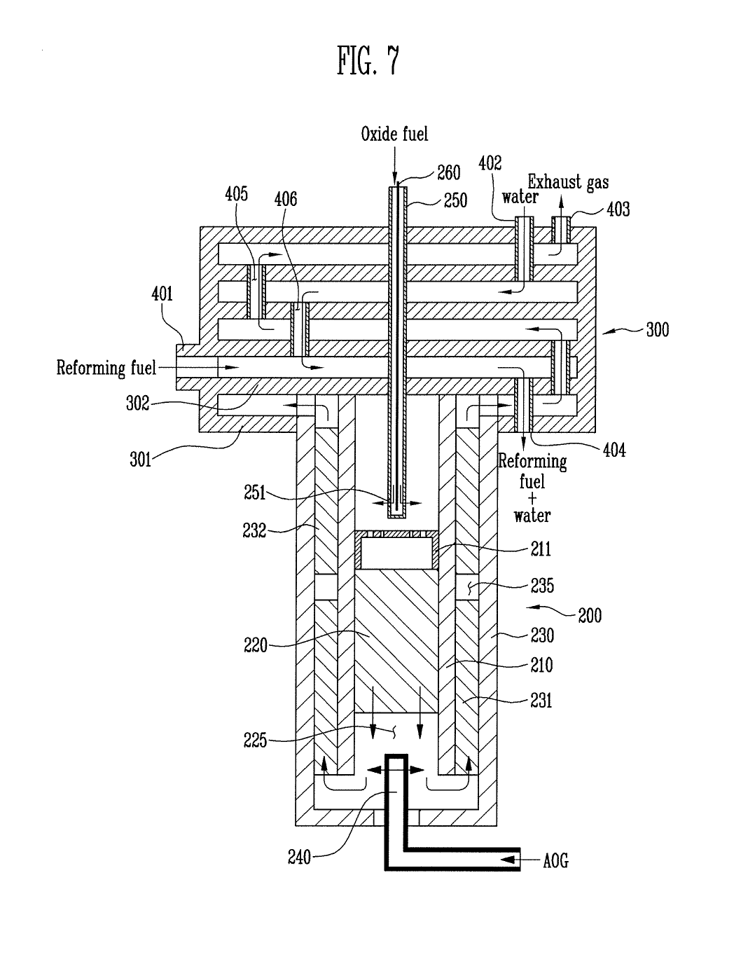

A combustor according to a second embodiment will be described with reference to FIG. 6. In this embodiment, AOG exhausted from an anode of the fuel cell 30 (see FIG. 1) is burned in the combustor 200 by recycling the AOG. That is, an AOG inlet port 240 for flowing the AOG into the first oxidation portion 225 therethrough is located at a lower portion of the first oxidation portion 225.

First, heat is generated by oxidizing the oxide fuel in the first oxidation catalyst layer 220. Subsequently, the oxide fuel not reacted at the lower portion of the first oxidation portion 225 and the AOG flowed into the first oxidation portion 225 through the AOG inlet port 240 are burned in flame. Finally, the non-reacted oxide fuel and the AOG are burned in the second oxidation catalyst layers 231 and 232 while moving through the second oxidation portion 235. The exhaust gas due to the combustion is exhausted to the exterior of the combustor 200.

In this case, hot spots are increasingly formed due to the AOG flowed into the first oxidation portion 225, and it is highly likely that flashback will occur in the first oxidation portion 225, as compared with the first embodiment. However, the flashback has no influence on the fuel discharge holes due to the high thermal capacity of the fuel distribution portion 211 described above.

### Third Embodiment

This embodiment including an evaporator 300 will be described with reference to FIG. 7.

The evaporator 300 is a component that evaporates water using heat energy of the exhaust gas exhausted from the combustor 200 and transfers the evaporated water together with the reforming fuel to a reformer. In FIG. 7, the evaporator 300 is configured by alternately arranging layers through which the water moves and layers through which the exhaust gas passes so as to increase the heat exchange efficiency of the exhaust gas. That is, the evaporator 300 is formed into a multi-layered structure divided into a plurality of plates, and allows the water and exhaust gas to move between the plates through flow path tubes, 402, 403, 404, 405 and 406. In an embodiment, the combustor inner wall 210 is welded to a second plate 302 at the bottom of the evaporator 300, and the combustor outer wall 230 is welded to a first plate 301 at the bottom of the evaporator 300. Through the aforementioned configuration, the combustor 200 and the evaporator 300 are connected to each other, so that welding points can be minimized or reduced, and heat transfer efficiency can be enhanced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A combustor for a reformer comprising:
an inner wall having a shape of a hollow cylinder with a first oxidation portion in a space therein;
a thermocouple extended to the first oxidation portion by passing through a top portion of the first oxidation portion for measuring a temperature of the first oxidation portion;
a fuel supply tube having a shape of a hollow cylinder surrounding the thermocouple, the fuel supply tube having fuel discharge holes at a lower portion thereof;
a fuel distribution portion located below the fuel supply tube, the fuel distribution portion having distribution nozzles through which fuel is distributed; and
a first oxidation catalyst layer located beneath the fuel distribution portion.

2. The combustor according to claim 1, wherein the inner wall has a shape of a hollow circular or polygonal cylinder.

3. The combustor according to claim 1, wherein the fuel supply tube has a shape of a hollow circular or polygonal cylinder.

4. The combustor according to claim 1, further comprising:
an outer wall surrounding the inner wall with a second oxidation portion in a space therebetween, a lower portion of the second oxidation portion being in fluid communication with the first oxidation portion; and
a second oxidation catalytic layer located in the second oxidation portion.

5. The combustor according to claim 1, wherein the fuel discharge holes are formed in a horizontal direction on a lower outer circumferential surface of the fuel supply tube.

6. The combustor according to claim 1, wherein the fuel distribution portion comprises a nozzle plate having distribution nozzles formed therein and a thermal capacity portion with a cylindrical shape extending downward from a periphery of the nozzle plate.

7. The combustor according to claim 6, wherein an area of the distribution nozzles increases in proportion to a distance from a center axis of the nozzle plate.

8. A reformer comprising:
an inner wall having a shape of a hollow cylinder with a first oxidation portion in a space therein;
an outer wall surrounding the inner wall with a second oxidation portion in a space therebetween, a lower portion of the second oxidation portion being in fluid communication with the first oxidation portion;
a fuel distribution portion in the first oxidation portion;
a first oxidation catalyst layer located beneath the fuel distribution portion;
a second oxidation catalyst layer located in the second oxidation portion;
a thermocouple extended to the first oxidation portion by passing through a top portion of the first oxidation portion so as to measure a temperature of the first oxidation portion;
a fuel supply tube having a shape of a hollow cylinder surrounding the thermocouple, the fuel supply tube having fuel discharge holes formed at a lower portion thereof, the fuel distribution portion located below the fuel supply tube, and the fuel distribution portion having distribution nozzles through which fuel is distributed;
an evaporator for receiving reforming fuel and water supplied thereto and for evaporating the supplied water using heat energy of exhaust gas exhausted from the second oxidation catalyst layer, and the evaporator for discharging the reforming fuel and the evaporated water; and
a reforming portion for receiving heat energy transferred from the first and second oxidation portions to reform the reforming fuel and the evaporated water from the evaporator.

9. The reformer according to claim 8, wherein the inner wall has a shape of a hollow circular or polygonal cylinder.

10. The reformer according to claim 8, wherein the fuel supply tube has a shape of a hollow circular or polygonal cylinder.

11. The reformer according to claim 8, wherein:
the evaporator comprises a plurality of plates formed in a multi-layered structure with a plurality of layers and flow path tubes for passing the water and exhaust gas between the layers so that the layers corresponding to the water and exhaust gas are alternately arranged;
the inner wall being welded to a second bottom plate at a bottom of the evaporator; and
the outer wall being welded to a first bottom plate at the bottom of the evaporator.

12. The reformer according to claim 8, wherein the fuel discharge holes are formed in a horizontal direction on a lower outer circumferential surface of the fuel supply tube.

13. The reformer according to claim 8, wherein the fuel distribution portion comprises a nozzle plate having distribution nozzles formed therein and a thermal capacity portion with a cylindrical shape extending downward from a periphery of the nozzle plate.

14. The reformer according to claim 13, wherein an area of the distribution nozzles increases in proportion to a distance from a center axis of the nozzle plate.
